(19) United States
(12) Patent Application Publication
(10) Pub. No.: US 2009/0272715 A1
(43) Pub. Date: Nov. 5, 2009

(54) NANOFABRICATION BASED ON SAM GROWTH

(75) Inventors: Dirk Burdinski, Eindhoven (NL); Ruben Bernardus Alfred Sharpe, Enschede (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/722,103

(22) PCT Filed: Dec. 14, 2005
(86) PCT No.: PCT/IB2005/054250

§ 371 Date: Jun. 19, 2007

(30) Foreign Application Priority Data
Dec. 23, 2004 (EP) 04106967.5

(51) Int. Cl. B05D 5/12; H01B 13/00

(52) U.S. Cl. 216/17; 427/98.4; 977/762

(57) ABSTRACT

The present invention relates to a process of nano fabrication based on nucleated SAM growth, to patterned substrates prepared thereby, to a nano wire or grid of nanowires prepared thereby and to electronic devices including the same. In particular, there is provided a process which comprises applying a first SAM-forming molecular species to a first surface region of the substrate surface, so as to provide a first SAM defining a scaffold pattern on the first surface region; and applying a second SAM-forming molecular species to at least a second surface region of said substrate surface which is not covered by the first SAM, whereby a second replica SAM comprising the second SAM-forming molecular species selectively forms on substrate surface adjacent to at least one edge of said first SAM.

The present invention relates to a process of nanofabrication based on nucleated SAM growth, to patterned substrates prepared thereby, to a nanowire or grid of nanowires prepared thereby and to electronic devices including the same.

Miniaturization offers many advantages, including for example process time, ease of use and mobility in diverse areas ranging from electronics fabrication to biosensor applications (Sprossler, C.; Scholl, M.; Denyer, M.; Krause, M.; Nakajima, K.; Maelicke, A.; Knoll, W.; Offenhauser, Synthetic Metals 2001, 117, 281-283). These applications call for cheap and reliable methods for creating extremely small patterns, preferably capable of patterning large and complex substrates. In electronic devices, the way such small areas are usually created is by means of optical lithography. This method does, however, have limitations with respect to the minimum available feature size as well as to the speed and cost of fabrication. Its use is furthermore restricted to flat substrates and cannot readily be extended for biological applications. Soft lithography (a variety of techniques which have in common that they employ a flexible polymeric mask) aims to overcome these limitations. It offers the opportunity to transfer directly, in a single step, local chemical functionality.

Microcontact printing (μCP) is a soft lithographic patterning technique, in which a patterned Self-Assembled Monolayer (SAM) can be transferred in the regions of contact between a structured polymeric stamp and a substrate. Patterned organic monolayers are of interest because they are able to shield the substrate to a large extent and to allow for local tunability of surface chemistry. Due to the use of a flexible stamp, and also because of the mobility of the ink molecules (the molecules that comprise the monolayer), it becomes increasingly difficult to create features that are smaller than about 1 μm WO 96/29629 describes a printing process, wherein a self-assembled molecular monolayer is formed on a surface of an article using μCP.

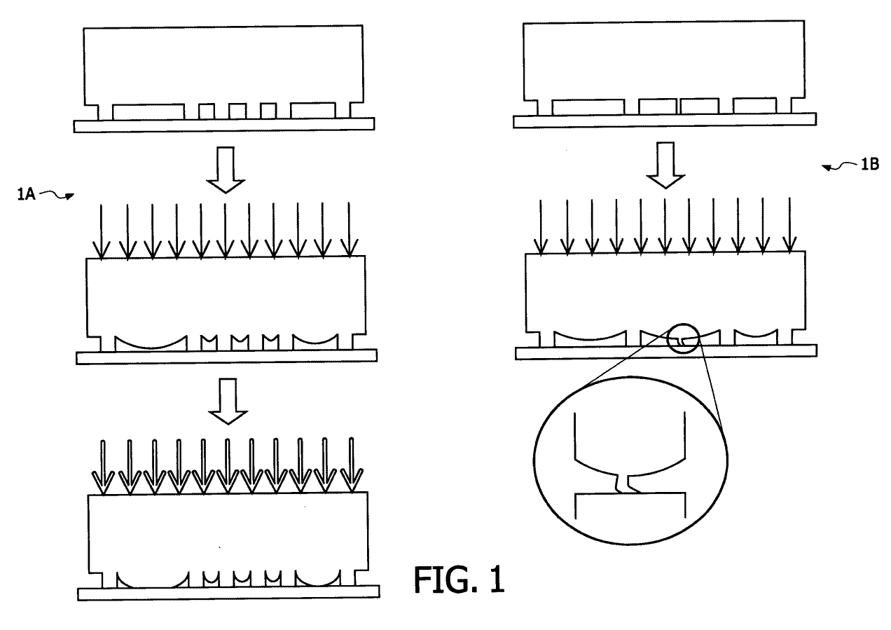

Microcontact printing is extremely versatile and at the present its applications appear to be mainly limited by the mechanical stability of the stamp. Especially troublesome is the printing of small isolated features. The hollow in the stamp between these features has to be relatively deep to prevent undesired contact because of sagging of the roof (squeezing) during printing as is illustrated in Scheme 1A of FIG. 1. This means that the features themselves are high with respect to their “footwidth” (have a high aspect ratio) and this makes them prone to buckling as is illustrated in Scheme IB of FIG. 1. Considerable research is directed at countering this limitation as illustrated by FIG. 1. Approaches include the deduction of design rules for stamp layout and stamp material (Alexander, B.; Michel, B. Journal of Applied Physics 2000, 88, 4310-4318; Hui, C.; Jaota, A.; Lin, Y.; Kramer, E. Langmuir 2002, 18, 1394-1407), development of novel printer designs for better control of the contact forces (Delamarche, E.; Vichiconti J.; Hall, S. A.; Geissler, M.; Graham, W.; Michel, B.; Nunes, R Langmuir 2003, 19, 6567-6569; U.S. Pat. No. 5,725,788; WO 03/065120), clever use of ink functionality and postprocessing (Delamarche, E.; Geissler, M.; Wolf, H.; Michel, B. J. Am. Chem. Soc. 2002, 124, 3834-3835) and stamp modification for control of ink transfer (Chemiavskaya, O.; Adzic, A.; Knutson, C.; Gross, B. J.; Zang, L.; Liu, R.; Adams, D. M. Langmuir 2002, 18, 7029-7034).

Isolated structures constitute an important part of electronic devices. Creating such isolated structures remains cumbersome when using soft-lithographic approaches. Although soft lithography, namely microcontact printing is very promising, it needs to overcome this obstacle in order to become commercially viable. Each of the prior art approaches discussed above poses limitations to the possible applications and there is a need, therefore, to develop a “toolbox” with approaches that cover as many possibilities as possible.

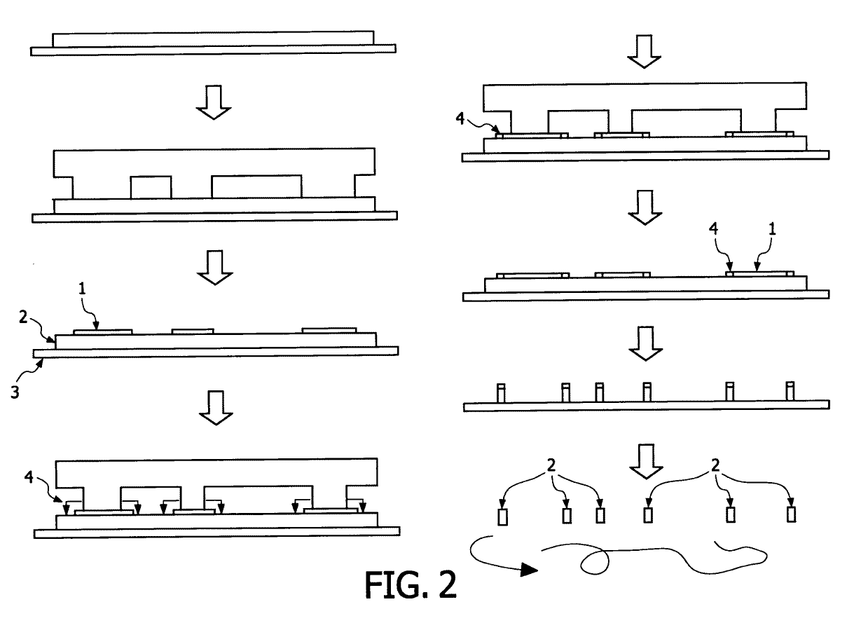

WO 04/013697 describes in one embodiment a method for producing at least one nanowire, or a grid of nanowires, of conducting, semi-conducting or insulating material. Nanowires are examples of structures that are not readily obtainable using μCP. Applications thereof are, for example, field emitters, wire grid polarizers or interconnects in micro- or nano-electronic devices. The method described in WO 04/013697 for creating nanowires entails a two step printing process which is also illustrated in FIG. 2, in which in the first step a scaffold pattern (1) is printed of a suitable ink, on the surface layer (2) of substrate (3), and on top of which scaffold pattern (1) in the second step a second ink (4) is printed that is able to and allowed to spread over and across the borders of the scaffold pattern (1). The overflowing second ink (4) is immobilized on the surface layer (2) of substrate (3) and therefore forms a rim (a ribbon or wire) that follows the contours of scaffold pattern (1). By controlling the amount of overflowing ink in (4), the dimensions of the resulting wire can be controlled. The second ink (4) may be selected to provide a high etch resistance and the nanowire pattern may thus be translated into metal nanowires of surface layer (2) of substrate (3) by chemical etching. The nature of the method, however, demands that the second print for ink (4) has to be aligned with the scaffold pattern (1). Moreover, the minimum dimensions of the first scaffold (1) are dictated by the minimum contact area of the second layer comprising ink (4). It has also recently been found that spreading on top of a preformed monolayer is not straightforward and the two inks need to be closely matched in order to achieve appreciable spreading on a reasonable time scale (within minutes).

It is an object of the invention to provide a process of nanofabrication based on nucleated SAM growth which does not demand that the second print for ink (4) has to be aligned with the scaffold pattern (1).

According to the present invention this object is achieved by a process of patterning at least one surface of a substrate, which process comprises:

(i) applying a first SAM-forming molecular species to a first surface region of said substrate surface, so as to provide a first SAM defining a scaffold pattern on said first surface region; and
(ii) applying a second SAM-forming molecular species to at least a second surface region of said substrate surface which is not covered by the first SAM, whereby a second replica SAM comprising said second SAM-forming molecular species selectively forms on substrate surface adjacent to at least one edge of said first SAM.

The invention is based on the following insight: the inventors have surprisingly found, that growth of a SAM beyond the regions of initial contact is not governed only by surface diffusion or solvent assisted transport (requiring a direct contact with the ink source i.e. the stamp). More particularly, we have found that an appreciable amount of SAM growth can occur, for example, by gas phase transport, and that molecular species can adhere selectively to the edge or edges of a preformed monolayer as hereinafter described in greater detail.

As referred to herein, application of the second SAM forming molecular species to the second surface region of the substrate surface represents direct (albeit preferably contactless) application of the second SAM-forming molecular species to the second surface region and does not, therefore, represent migration of the second SAM-forming molecular species thereto, as for example is seen in the prior art as illustrated by WO 04/013697. It is, of course, appreciated that migration of the second SAM-forming molecular species to the second surface region (which can include substrate surface adjacent to at least one edge of the first SAM on which the second replica SAM forms) can additionally occur, as indeed is hereinafter illustrated with reference to the Figures. Additionally, it can be preferred that the second surface region not only comprises substrate surface not covered by the first SAM but also further comprises substrate surface outside the substrate surface area to be patterned.

It is thus preferred that application of the second SAM-forming molecular species does not include selective application to the first SAM as is seen for example in WO 04/013697, and in a preferred embodiment there is provided a process of patterning at least one surface of a substrate, which process comprises:

(i) applying a first SAM-forming molecular species to a first surface region of said substrate surface, so as to provide a first SAM defining a scaffold pattern on said first surface region; and
(ii) applying a second SAM-forming molecular species to at least a second surface region of said substrate surface which is not covered by the first SAM and optionally also to the surface of said first SAM present on said first surface region of said substrate surface, whereby a second replica SAM comprising said second SAM-forming molecular species selectively forms on substrate surface adjacent to at least one edge of said first SAM; characterized in that application of said second SAM-forming molecular species in step (ii) does not include selective application to the surface of said first SAM.

These and other aspects of the invention will be further described with reference to the Figures.

FIG. 1 is a cross section of the substrate and the stamp in a prior art process,

FIG. 2 depicts the method described in WO 04/013697 for creating nanowires, entailing a two-step printing process,

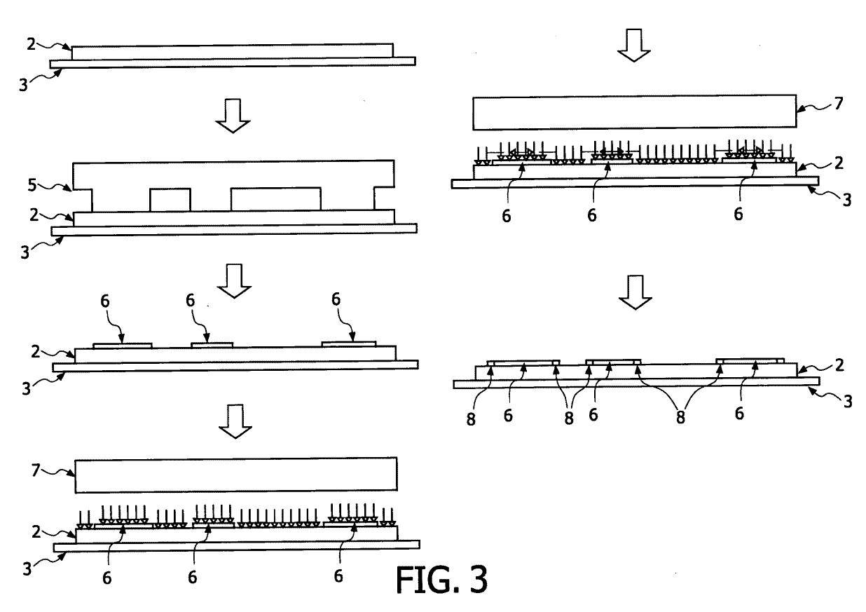

FIG. 3 illustrates a process according to the present invention of forming first and second SAMs on a substrate surface,

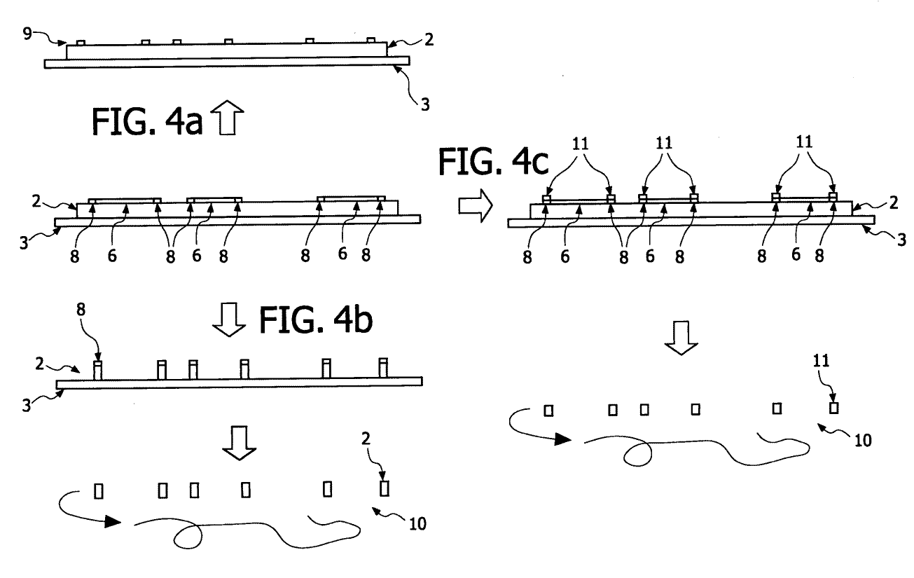

FIG. 4(a) shows the formation of a nanopattern on substrate surface layer further to selective removal of scaffold pattern of the first SAM,

FIG. 4(b) illustrates selective etching to remove each of the first scaffold SAM together with surface layer underlying the SAM,

FIG. 4(c) illustrates formation of at least one nanowire or grid of nanowires,

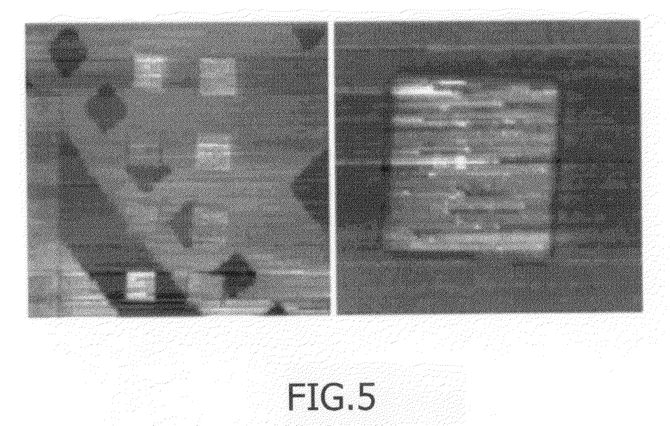

FIG. 5 shows AFM friction images of substrates obtained by the method according to the invention.

A process according to the present invention of forming first and second SAMs on a substrate surface is further illustrated by FIG. 3, where there is patterned surface layer (2) of substrate (3). A stamp (5) loaded with an ink comprising a first SAM-forming molecular species is brought into contact with surface layer (2) of substrate (3). A scaffold pattern (6) of a first SAM comprising the first SAM-forming molecular species of the ink is provided on surface layer (2). A reservoir (7) comprising the second SAM-forming molecular species provides the second SAM-forming molecular species to scaffold pattern (6), and the illustrated remaining uncoated surface layer (2), and the second SAM-forming molecular species subsequently migrates away from the surface of scaffold pattern (6) and forms a second SAM replica pattern (8) adjacent the edges of the SAM scaffold pattern (6).

A process according to the present invention can further comprise a selective etching step so as to selectively remove the scaffold pattern as defined by the first SAM, thereby providing a substrate selectively patterned with the second replica SAM and where required a further patterned material applied thereto.

A process as now provided by the present invention offers considerable advantage over known techniques and in particular the fabrication of nanometer wide surface features or free standing nanowires as hereinafter described by selective deposition of material in patterned regions of the substrate or selective etching of the patterned substrate material as illustrated in FIG. 4. In FIG. 4, scheme 4(a) shows the formation of a nanopattern (9) on substrate surface layer (2) further to selective removal of scaffold pattern (6) of the first SAM as further illustrated in FIG. 3. In the formation of such a nanopattern, it is generally preferred that the first and second SAM-forming molecular species exhibit different exposed surface functionalities substantially as hereinafter described in greater detail. Scheme 4(b) illustrates selective etching to remove each of the first scaffold SAM (6) as illustrated in FIG. 3, together with surface layer (2) underlying SAM (6), and also further selective etching so as to remove underlying substrate (3) and second SAM (8), to thus form at least one nanowire or grid of nanowires (10) formed of surface layer material (2). Scheme 4(c) similarly illustrates formation of at least one nanowire or grid of nanowires (10), but where the nanowire or grid or nanowires is formed by material (11) deposited on second SAM (8) followed by selective etching to remove SAMs (6) and (8) and underlying substrate materials (2) and (3).

According to the present invention, therefore, there is further provided a process of providing at least one nanowire, or a grid of nanowires, which process comprises:

(i) providing a substrate comprising a substrate body underlying a substrate surface comprising substrate surface material;
(ii) applying a first SAM-forming molecular species to a first surface region of said substrate surface, so as to provide a first SAM defining a scaffold pattern on said first surface region;
(iii) applying a second SAM-forming molecular species to at least a second surface region of said substrate surface which is not covered by the first SAM, whereby a second replica SAM comprising said second SAM-forming molecular species selectively forms on substrate surface adjacent to at least one edge of said first SAM (wherein preferably application of said second SAM-forming molecular species does not include selective application to the surface of said first SAM);
(iv) carrying out selective etching so as to remove at least said first scaffold SAM and substrate surface material underlying said first SAM, and also essentially the entire underlying substrate body specified in step (i); and
(v) either isolating remaining substrate surface comprising said substrate surface material, with or without said second replica SAM, or isolating patterned material that has been selectively applied to said second replica SAM, with or without said second replica SAM.

According to the above process, in step (v) the referenced patterned material can be selectively applied to the second SAM at selected stages in the above process as follows. Firstly, the patterned material can be selectively applied to the second replica SAM as formed in step (iii) prior to the selective etching of step (iv). Alternatively, the patterned material can be selectively applied to the second replica SAM after selective removal of at least the first SAM in step (iv), and in certain embodiments after selective removal in step (iv) of both the first SAM and also underlying substrate surface material.

It should also be appreciated that the substrate surface material and the material of the underlying substrate body can be the same or different, provided the surface material facilitates SAM growth thereon as hereinafter described in greater detail.

Selective formation of the second SAM as described herein means that the second SAM-forming molecular species selectively migrates to substrate surface adjacent the at least one edge of the first SAM, where the adjacent substrate surface region typically has a lateral dimension of about 1 to 100 nm. In a preferred embodiment, the second SAM-forming molecular species is applied to both the second surface region of the substrate surface, and to the surface of the first SAM, and subsequently the second SAM thus forms on the substrate surface adjacent to the at least one edge of the first SAM further to migration of the second SAM-forming molecular species thereto. In this embodiment, the second surface region, to which the second SAM-forming molecular species is applied, includes as least the substrate surface adjacent to the at least one edge of the first SAM on which the second SAM selectively forms and can preferably comprise uncoated surface of the substrate extending between respective portions of the first SAM which can thus include substrate surface outside the area of substrate surface to be patterned. Preferably, therefore, the application can include substantially uniform application to the substrate surface and also the surface of the first SAM. Alternatively, it may be preferred that the second SAM-forming molecular species is applied to a second surface region of the substrate surface which is spaced from at least one edge of the first SAM and thus again includes substrate surface outside the area of substrate surface to be patterned, and the second surface region is so located on the substrate surface as to allow the second SAM-forming molecular species when applied thereto to migrate to the substrate surface adjacent to at least one edge of the first SAM and thereby selectively form the second replica SAM on the substrate surface adjacent to at least one edge of the first SAM. According to the present invention, it has been found that patterning of the second replica SAM is guided by the scaffold pattern of the first SAM and that as indicated above a second replica SAM comprising the second SAM-forming molecular species selectively forms on substrate surface adjacent to at least one edge of the first SAM.

Without wishing to be bound by the underlying theory, the inventors consider that there are two effects that are important for the preferential deposition of the second replica SAM adjacent at least one edge of the first SAM. The first effect is based on considerations concerning the thermodynamics of the SAM formation process. In thermodynamic equilibrium a cluster of molecules (in this case a SAM) corresponds to a certain surface density of free, non-clustered molecules. The density is related to the dimensions of the cluster. Smaller radii of curvature (small clusters or sharp features) correspond to higher surface densities.

$$ρ = exp [ \frac{γ \cdot Ω / r - E}{kT} ] \qquad ( I )$$

In equation (I) ρ denotes the equilibrium surface density corresponding to a cluster with radius r, edge free energy γ, 2D-condensation enthalpy (heat associated with taking one molecule from the cluster and transferring it infinitely far away) E and an area Ω occupied by a molecule in the cluster. For small clusters in the vicinity of larger clusters that consist of identical molecules, the gradient in surface density will give rise to diffusional transport from the small to the large clusters. The latter effectively “eating” the former (Ostwald ripening). The same will be true when the clusters are made up from different kinds of molecules, provided that the energy cost of creating an interface between the two kinds of molecules is not too high. Because the preformed monolayer is always larger than any cluster that may spontaneously emerge during deposition, freshly deposited molecules will tend to diffuse and adhere to the preformed pattern edge or edges.

The second effect results from considering the kinetics of SAM formation. The rate of adhesion of molecules to a surface is basically governed by the rate at which the molecules “visit” the surface (the impingement rate) and the probability that they get permanently bound. The latter is related to the time a non-bound molecule remains at the substrate's surface (residence time) and the probability that it has the correct orientation for binding. Due to the nature of self-assembling molecules they have a relatively high affinity for each other. Therefore, in the vicinity of a preformed monolayer, molecules may have a longer residence time than in the regions of bare substrate. Moreover, because their tendency to optimize their Van der Waals interaction, newly arriving molecules will tend to align with the existing monolayer, thereby increasing the probability of a favorable orientation.

These considerations promise the possibility of a range of approaches towards growing wires on the edges of preformed monolayers. Once the scaffold SAM is printed, no further positional control is needed for deposition of the second SAM. Only the amount of the deposited material has to be controlled. Also, apart from the inks being able to form SAMs, there are hardly any additional demands on the ink.

An underlying substrate surface and SAM-forming molecular species are preferably selected such that the molecular species terminates at a first end in a functional group that binds to the desired surface (the substrate or a surface film or coating applied thereto). As used herein, the terminology “end” of a molecular species, and “terminates” is meant to include both the physical terminus of a molecule as well as any portion of a molecule available for forming a bond with a surface in a way that the molecular species can form a SAM, or any portion of a molecule that remains exposed when the molecule is involved in SAM formation. A SAM-forming molecular species typically comprises a molecule having first and second terminal ends, separated by a spacer portion, the first terminal end comprising a functional group selected to bond to a surface (the substrate or a surface film or coating applied thereto), and the second terminal group optionally including a functional group selected to provide a SAM on the surface having a desirable exposed functionality. The spacer portion of the molecule may be selected to provide a particular thickness of the resultant SAM, as well as to facilitate SAM formation. Although SAMs of the present invention may vary in thickness, as described below, SAMs having a thickness of less than about 100 Angstroms are generally preferred, more preferably those having a thickness of less than about 50 Angstroms and more preferably those having a thickness of less than about 30 Angstroms. These dimensions are generally dictated by the selection of the SAM-forming molecular species and in particular the spacer portion thereof.

A wide variety of underlying surfaces (exposing substrate surfaces on which a SAM will form) and SAM-forming molecular species are suitable for use in the present invention. A non-limiting exemplary list of combinations of substrate surface material (which can be the substrate itself or a film or coating applied thereto) and functional groups included in the SAM-forming molecular species is given below. Preferred substrate surface materials can include metals such as gold, silver, copper, cadmium, zinc, nickel, cobalt, palladium, platinum, mercury, lead, iron, chromium, manganese, tungsten, and any alloys of the above typically for use with sulfur-containing functional groups such as thiols, sulfides, disulfides, and the like, in the SAM-forming molecular species; doped or undoped silicon with silanes and chlorosilanes; surface oxide forming metals or metal oxides such as silica, indium tin oxide (ITO), indium zinc oxide (IZO) magnesium oxide, alumina, quartz, glass, and the like, typically for use with carboxylic acids or heteroorganic acids including phosphonic, sulfonic or hydroxamic acids, alkoxylsilyl and halosilyl groups, in the SAM-forming molecular species; platinum and palladium typically for use with nitrites and isonitriles, in the SAM-forming molecular species. Additional suitable functional groups in the SAM-forming molecular species can include acid chlorides, anhydrides, hydroxyl groups and amino acid groups. Additional substrate surface materials can include germanium, gallium, arsenic, and gallium arsenide.

Preferably, however, an underlying exposing substrate surface on which a SAM will form for use in a process according to the present invention typically comprises a metal substrate, or at least a surface of the substrate, or a thin film or coating deposited on the substrate, on which the pattern is printed, comprises a metal, which can suitably be selected from the group consisting of gold, silver, copper, cadmium, zinc, nickel, cobalt, palladium, platinum, mercury, lead, iron, chromium, manganese, tungsten and any alloys of the above. Preferably the substrate, or at least a surface of the substrate on which the pattern is printed, comprises gold. The exposed substrate surfaces to be coated with a SAM may thus comprise a substrate itself, or may be a thin film or coating deposited upon a substrate or substrate body, or may include patterned layers of conducting and insulating material. Where a separate substrate or substrate body is employed, it may be formed of a conductive, nonconductive, semiconducting material, or the like.

In a preferred embodiment of the present invention, a combination of gold as an underlying substrate surface material on which is to be formed a SAM and a SAM-forming molecular species having at least one sulfur-containing functional group, such as a thiol, sulfide, or disulfide is selected. The interaction between gold and such sulfur-containing functional groups is well recognized in the art.

The central portion of molecules comprising SAM-forming molecular species generally includes a spacer functionality connecting the functional group selected to bind to a surface and the exposed functionality. Alternatively, the spacer may essentially comprise the exposed functionality, if no particular functional group is selected other than the spacer. Any spacer that does not disrupt SAM packing is suitable. The spacer may be polar, nonpolar, positively charged, negatively charged, or uncharged. For example, a saturated or unsaturated, linear or branched hydrocarbon or halogenated hydrocarbon containing group may be employed. The term hydrocarbon as used herein can denote straight-chained, branched and cyclic aliphatic and aromatic groups, and can typically include alkyl, alkenyl, alkynyl, cycloalkyl, cycloalkylalkyl, aryl, arylalkyl, arylalkenyl and arylalkynyl. The term “hydrocarbon containing group” also allows for the presence of atoms other than carbon and hydrogen, typically for example, oxygen and/or nitrogen. For example, one or more methylene oxide, or ethylene oxide, moieties may be present in the hydrocarbon containing group; alkylated amino groups may also be useful. Suitably, the hydrocarbon groups can contain up to 35 carbon atoms, typically up to 30 carbon atoms, and more typically up to 20 carbon atoms. Corresponding halogenated hydrocarbons can also be employed, especially fluorinated hydrocarbons. In a preferred case the fluorinated hydrocarbon can be represented by the general formula F(CF₂)ₖ(CH₂)₁, where k is typically an integer having a value between 1 and 30 and l is an integer having a value of between 0 and 6. More preferably, k is an integer of between 5 and 20, and particularly between 8 and 18. It is of course recognized that although the above are given as preferred ranges for the values of k and l, the particular choice of k and l can be varied in accordance with the principles of the present invention. It will also be appreciated that the term “hydrocarbon containing group” also allows for the presence of atoms other than carbon and hydrogen, typically O or N, as explained above.

The above hydrocarbon spacer groups can also be further substituted by substituents well known in the art, such as C₁₋₆alkyl, phenyl, C₁₋₆haloalkyl, hydroxy, C₁₋₆alkoxy, C₁₋₆alkoxyalkyl, C₁₋₆alkoxyC₁₋₆alkoxy, aryloxy, keto, C₂₋₆alkoxycarbonyl, C₂₋₆alkoxycarbonylC₁₋₆alkyl, C₂₋₆alkylcarbonyloxy, arylcarbonyloxy, arylcarbonyl, amino, mono- or di-(C₁₋₆)alkylamino, or any other suitable substituents known in the art.

A SAM-forming molecular species may terminate in a second end opposite the end bearing the functional group selected to bind to particular substrate material in any of a variety of functionalities. According to the present invention it is preferred that a first SAM-forming molecular species as described herein terminates at a first end in a functional group that binds to the desired substrate surface and terminates at a second end in a functionality that is exposed when the species forms a SAM and which comprises a polar group. It is also preferred in accordance with the present invention that a second SAM-forming molecular species as described herein terminates at a first end in a functional group that binds to the desired substrate surface and terminates at a second end in a functionality that is exposed when the species forms a SAM and which comprises a non-polar group. Examples of suitable polar groups include —OH, —CONH, —NCO, —NH₂, —COOH, —NO₂, —COH, —COCl, —PO₄²⁻, —OSO₃⁻, —SO₃⁻, —CONH₂, —(OCH₂CH₂)ₙOH, —(OCH₂CH₂)ₙOCH₃ (where n=1-100), —PO₃H⁻, —CN, —SH, —CH₂I, —CH₂Cl and —CH₂Br. A suitable non-polar group can be an alkyl group. According to the same embodiments the functional group would literally define a terminus of the molecular species, while according to other embodiments the functional group would not literally define a terminus of the molecular species, but would be exposed.

Thus, a SAM-forming molecular species generally comprises a species having the generalized structure R′-A-R″, where R′ is selected to bind to a particular surface of material, A is a spacer, and R″ is a group that is exposed when the species forms a SAM and is selected to exhibit a required surface property substantially as hereinbefore described. Also, the molecular species may comprises a species having the generalized structure R″-A′-R′-A-R″, where A′ is a second spacer or the same as A, or R′″-A′-R′-A-R″, where R′″ is the same or different exposed functionality as R″.

Suitably, therefore, a SAM-forming molecular species can be selected from sulfur-containing molecules, such as alkyl- or aryl thiols, disulfides, dithiolanes or the like, carboxylic acids, sulfonic acids, phosphonic acids, hydroxamic acids or the like, or other reactive compounds, such as silyl halides or the like.

A particular class of molecules suitable for use as a SAM-forming molecular species for use with a gold, silver or copper substrate include functionalized thiols having the generalized structure R′-A-R″, where R′ can denote —SH, A can denote a hydrocarbon or halogenated hydrocarbon containing group, and R″ can denote a functional end group. A preferred example of a first SAM-forming molecular species is 16-mercaptohexadecanoic acid (MHDA). A preferred example of a second SAM-forming molecular species is octadecanethiol (ODT).

A first SAM provided according to the present invention can be formed by suitable techniques known in the art, for example by adsorption from solution, or from a gas phase, or may be applied by use of a stamping step employing a flat unstructured stamp or may be applied by a microcontact printing technique which is generally preferred for use in applying a first SAM in accordance with a process of the present invention. Preferably, a patterned stamp defining a required pattern is loaded with an ink comprising the first SAM-forming molecular species and is brought into contact with the surface of the substrate to be patterned, with the patterned stamp being arranged to deliver the ink to the contacted areas of the surface of the substrate.

Typically, a stamp employed in a method according to the present invention includes at least one indentation, or relief pattern, contiguous with a stamping surface defining a first stamping pattern. The stamp can be formed from a polymeric material. Polymeric materials suitable for use in fabrication of a stamp include linear or branched backbones, and may be cross-linked or non-cross-linked, depending on the particular polymer and the degree of formability desired of the stamp. A variety of elastomeric polymeric materials are suitable for such fabrication, especially polymers of the general class of silicone polymers, epoxy polymers and acrylate polymers. Examples of silicone elastomers suitable for use as a stamp include the chlorosilanes. A particularly preferred silicone elastomer is polydimethylsiloxane (PDMS).

Generally, a first SAM-forming molecular species is dissolved in a solvent for transfer to a stamping surface. The concentration of the molecular species in such a solvent for transfer should be selected to be low enough that the species is well-absorbed into the stamping surface, and high enough that a well-defined first SAM may be transferred to the substrate surface without blurring. Typically, the first SAM-forming molecular species will be transferred to a stamping surface in a solvent at a concentration of less than 100 mM, preferably from about 0.5 to about 20.0 mM, and more preferably from about 1.0 to about 10.0 mM. Any solvent within which the molecular species dissolves, and which may be carried (e.g. absorbed) by the stamping surface, is suitable. In such selection, if a stamping surface is relatively polar, a relatively polar and/or protic solvent may be advantageously chosen. If a stamping surface is relatively nonpolar, a relatively nonpolar solvent may be advantageously chosen. For example, toluene, ethanol, THF, acetone, isooctane, cyclohexane, diethyl ether, and the like may be employed. When a siloxane polymer, such as polydimethyl siloxane elastomer (PDMS) as referred to above, is selected for fabrication of a stamp, and in particular a stamping surface, toluene, ethanol, cyclohexane, decalin, and THF are preferred solvents. The use of such an organic solvent generally aids in the absorption of the first SAM-forming molecular species by a stamping surface. When the molecular species is transferred to the stamping surface, either near or in a solvent, the stamping surface should be dried before the stamping process is carried out. If a stamping surface is not dry when the SAM is stamped onto the material surface, blurring of the SAM can result. The stamping surface may be air dried, blow dried, or dried in any other convenient manner. The drying manner should simply be selected so as not to degrade the SAM-forming molecular species.

Preferably, the second SAM-forming molecular species may be applied to the second surface region of the substrate surface and/or to the surface of the first SAM by contactless gas phase deposition which employs a low concentration of the second SAM-forming molecular species, or other known deposition strategy which does not comprise selective application to the first SAM and as such does not require positional alignment of a patterning template or positional control so as to effect selective transfer of the second SAM-forming molecular species from a patterning template to the first SAM. Suitable application techniques thus comprise gas phase deposition, or solution deposition, for example, dip coating or spraying. Microcontact printing can be employed for application of the second SAM-forming molecular species, for example where the second SAM-forming molecular species is applied to a second surface region of the substrate surface which is spaced from at least one edge of the first SAM, although the stamp is not aligned so as to effect selective application of the second SAM-forming molecular species to the surface of the first SAM as required in the prior art, for example WO 04/013697.

In a specific embodiment of the present invention we have printed a gold substrate with 16-mercaptohexadecanoic acid (MHDA) and n-octadecanethiol (ODT) using a patterned stamp in both steps. FIG. 5 shows AFM friction images of such printed substrates. The stamp patterns were not aligned with respect to each other so that in the final substrates surface regions were observed, in which contact with a stamp occurred never, only once (with a stamp loaded with either of the two inks) or twice (once with each of the two stamps). In the friction images of FIG. 5 very dark regions (with respect to the background) indicate SAM areas with a low friction consisting of mainly ODT molecules and light regions with a high friction consisting of mainly MHDA molecules. Inspection of FIG. 5 reveals low friction lines around isolated light features (high friction) even in areas where no direct contact had occurred between the ODT loaded stamp and the substrate in the second printing step. This demonstrates that ODT has migrated to the edges of the MHDA pattern, without there being direct contact of the stamp and the pattern (thus vapour phase deposition). With further reference to FIG. 5, there are shown friction force AFM images of a gold substrate subsequently printed with 16-mercaptohexadecanoic acid (MHDA) and n-octadecanethiol (ODT). The left image is 100 μm×100 μm and the right image is 22 μm×22 μm. The dark lines (low friction) around isolated light features (high friction) indicate that ODT has migrated to the edges of the MHDA pattern, without there being direct contact of the stamp and the pattern (thus vapour phase deposition). The ODT lines were grown within 30 seconds.

Ostwald ripening is a very slow process for the commonly used inks because of their low mobility once a cluster is established. A suitable choice of molecules and temperature of deposition may be thought to increase the rate of the ripening process. Furthermore, the catalytic effect of the SAM can be exploited to its fullest potential by decreasing the deposition rate, decreasing the molecules' affinity for the bare substrate and increasing its affinity for the preformed monolayer.

There is also provided by the present invention a process of manufacturing an electronic device which includes a patterned substrate prepared substantially as hereinbefore described. Suitable electronic devices include, for example, transistors, biosensors, LCDs and optical devices.

There is also provided by the present invention a process of manufacturing an electronic device which includes at least one nanowire, or a grid of nanowires, prepared substantially as hereinbefore described. As used herein, the term “nanowire” is not restricted to wires having a symmetrical cross section. A nanowire as provided by the present invention may also be referred to as a nanoribbon. Examples of electronic devices comprising such nanowires, or a grid of nanowires, are field emitters, wire grid polarizers and microelectronic devices.

1. A process of patterning at least one surface of a substrate, which process comprises:
(i) applying a first SAM-forming molecular species to a first surface region of said substrate surface, so as to provide a first SAM defining a scaffold pattern on said first surface region; and
(ii) applying a second SAM-forming molecular species to at least a second surface region of said substrate surface which is not covered by the first SAM, whereby a second replica SAM comprising said second SAM-forming molecular species selectively forms on substrate surface adjacent to at least one edge of said first SAM.

2. A process according to claim 1, which further comprises a selective etching step so as to selectively remove said first SAM so as to provide a substrate selectively patterned with at least the second replica SAM.

3. A process of providing at least one nanowire, or a grid of nanowires, which process comprises:
(i) providing a substrate comprising a substrate body underlying a substrate surface comprising substrate surface material;
(ii) applying a first SAM-forming molecular species to a first surface region of said substrate surface, so as to provide a first SAM defining a scaffold pattern on said first surface region;
(iii) applying a second SAM-forming molecular species to at least a second surface region of said substrate surface which is not covered by the first SAM, whereby a second replica SAM comprising said second SAM-forming molecular species selectively forms on substrate surface adjacent to at least one edge of said first SAM;
(iv) carrying out selective etching so as to remove at least said first scaffold SAM and substrate surface material underlying said first SAM, and also essentially the entire underlying substrate body specified in step (i); and
(v) either isolating remaining substrate surface comprising said substrate surface material, with or without said second replica SAM, or isolating patterned material that has been selectively applied to said second replica SAM, with or without said second replica SAM.

4. A process according to 1, wherein said second SAM-forming molecular species is applied to both the second surface region of the substrate surface, and to the surface of the first SAM.

5. A process according to claim 1, wherein said first SAM-forming molecular species terminates at a first end in a functional group that binds to said substrate surface and terminates at a second end in a functionality that is exposed when the species forms a SAM and which comprises a polar group.

6. A process according to claim 5, wherein said first SAM-forming molecular species is 16-mercaptohexadecanoic acid.

7. A process according to claim 1, wherein said second SAM-forming molecular species terminates at a first end in a functional group that binds to said substrate surface and terminates at a second end in a functionality that is exposed when the species forms a SAM and which comprises a non-polar group.

8. A process according to claim 7, wherein said second SAM-forming molecular species is octadecanethiol.

9. A process according to 1, wherein said first SAM-forming molecular species is applied to said substrate surface by microcontact printing.

10. A process according to claim 1, wherein said second SAM-forming molecular species is substantially uniformly applied to said substrate surface and the surface of the first SAM.

11. A process according to claim 1, wherein said second SAM-forming molecular species is applied by contactless deposition.

12. A process according to claim 11, wherein said second SAM-forming molecular species is applied by gas phase deposition.

13. A process of manufacturing an electronic device which includes a patterned substrate prepared according to claim 1.

14. A process of manufacturing an electronic device which includes at least one nanowire, or a grid of nanowires, prepared by a process according to claim 3.
